(19) United States
(12) Patent Application Publication
(10) Pub. No.: US 2007/0027805 A1
(43) Pub. Date: Feb. 1, 2007

(54) Method and an apparatus for providing email billing without requiring reprogramming

(76) Inventor: David Andrew Graves, Monte Sereno, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/193,524

(22) Filed: Jul. 29, 2005

(51) Int. Cl. G06Q 40/00

(52) U.S. Cl. 705/40

(57) ABSTRACT

Embodiments of the present invention pertain to methods and apparatuses for providing flexible email billing without requiring reprogramming is described. In one embodiment, a first billing model is associated with a mail costs table. The first billing model provides a guideline for computing a bill for a customer using an email service. The mail costs table can be selectively modified without requiring the reprogramming of the email billing application. The computing of the bill for the customer based on the mail costs table is enabled.

### TECHNICAL FIELD

Embodiments of the present invention relate to electronic billing systems. More specifically, embodiments of the present invention relate to providing flexible email billing without requiring reprogramming.

### BACKGROUND

There is an emerging trend for purchasing electronic mail service from an external service provider with billing based on customer usage, since this may be significantly less expensive than purchasing equipment to run an electronic mail application in-house. One of the requirements for an electronic email billing application is measuring (also referred to as “metering”) the usage of the system. Failing to measure the appropriate parameters (also referred to as “billable metrics”) may result in customer abuse of the email billing application, such as using the electronic mail system as an electronic filing system or an electronic file transfer system, and such abuses will result in poor profit margins for the service provider, as will become more evident.

Frequently a customer is a company with many employees that use an email service. Typically, customers have a difficult time determining how their employees are abusing the email service and therefore have a difficult time in reducing their email bills, as will become more evident.

Further, conventional email billing application are inflexible in measuring usage and calculating charges. For example, conventional email billing application typically need to be reprogrammed when a customer wants or needs to be billed using a new billing model. This inflexibility leads to a number of problems. For example, one of the problems is a lack of customer satisfaction due to the difficulties in changing the billing models to meet the customer's needs. This may further result in low sales of the email service due to a lack of customer satisfaction, low motivation of the personnel selling the email service due to the difficulties in tailoring the email service to meet the customer's needs, and low profit margins for the service provider. Finally, the service provider's profit margins may be low because of the high cost of customizing conventional email billing application or the high cost of producing a new email billing system from scratch, among other things.

### DISCLOSURE OF THE INVENTION

Embodiments of the present invention pertain to methods and apparatuses for providing flexible email billing without requiring reprogramming is described. In one embodiment, a first billing model is associated with a mail costs table. The first billing model provides a guideline for computing a bill for a customer using an email service. The mail costs table can be selectively modified without requiring the reprogramming of the email billing application. The computing of the bill for the customer based on the mail costs table is enabled.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an apparatus that provides flexible email billing without requiring reprogramming, according to embodiments of the present invention.

FIG. 2 depicts a block diagram of part of an email billing system in the context of an email system, according to embodiments of the present invention.

FIGS. 3A-3C depict various billing models, according to embodiments of the present invention.

FIG. 4 depicts a block diagram of part of an email billing system in the context of an email system, according to embodiments of the present invention.

FIG. 5 depicts flowchart 500 for a method of providing flexible email billing without requiring reprogramming, according to embodiments of the present invention.

FIG. 6 depicts flowchart 600 for a method of computing a bill for a customer based on a billing model, according to embodiments of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

Conventional email billing application hardcode billing models for a few billable metrics that are easy to measure, such as the number of users or the number of emails transmitted. In contrast, any number of different types of billable metrics, such as the size of emails, the priority of emails, the number of recipients of an email, can be used according to embodiments of the present invention.

Conventional email billing application typically use a billing model known as flat rate. Since the billing model is hard coded into conventional email billing application, the billing model cannot be easily changed. For example, a customer may want to be charged based on a low flat rate for a certain number of messages and then be charged on a per message basis thereafter. However, conventional email billing application have hardcoded billing models, and therefore have to be re-programmed or programmed from scratch in order to change the billing model for a customer.

According to embodiments of the present invention, an easy to modify email costs table is provided. For example, any billing model that uses any billable metric can be associated with the email costs table, according to embodiments of the present invention. According to embodiments of the present invention, the email billing system can use the billable metrics that make sense rather than just the billable metrics that are easy to measure.

Many different types of billing models can be associated with the email costs table to provide a guideline for billing a customer, according to another embodiment. By changing values in an email costs table, the billing model for a customer can be easily changed (e.g., is flexible) without requiring reprogramming of an email billing system. Since the email billing system provided by embodiments of the present invention is flexible, customer's needs can be easily addressed.

Further, if customers are abusing an email system, the billing model can easily be changed to prevent that. For example, conventional email billing application typically hardcode their billing model based on the number of users. If email users use their email boxes as file systems by storing store large amounts of data in their mail boxes, the email service providers are not in a position to recover their costs for storing the large amounts of data. With embodiments of the present invention, abuses can easily be detected and remedied by changing the billing model. For example, the billing model can be easily changed to charge customers for the amount of data stored in their mail boxes or to charge customers for the amount of data transmitted in their emails. Another example of abuse is sending large attachments to many recipients. In either example of abuse, shared file systems are a more appropriate way storing and communicating data. Additionally, the sales personnel will be more motivated to sell email services since it will be easier for them to meet their customer's needs and the profit margins of an email service provider will increase, as will become more evident.

### An Apparatus that Provides Flexible Email Billing without Requiring Reprogramming

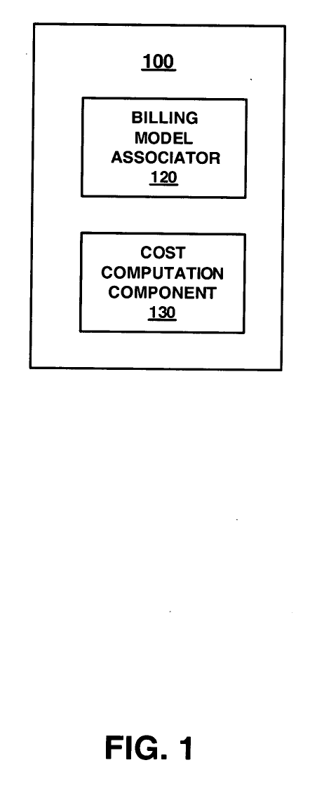

FIG. 1 is a block diagram of an apparatus that provides flexible email billing without requiring reprogramming, according to embodiments of the present invention. The blocks that represent features in FIG. 1 can be arranged differently than as illustrated, and can implement additional or fewer features than what are described herein. Further, the features represented by the blocks in FIG. 1 can be combined in various ways. The apparatus 100 can be implemented with software, firmware, hardware, or with a combination thereof.

The apparatus 100 includes a billing model associator 120 and a cost computation component 130. The billing model associator 120 associates billing models with a mail costs table. Billing models provide a guideline for computing a bill for a customer that uses an email service. The billing model associator 120 can also be used for changing the billing model, for example, by associating a new billing model with the mail costs table, for example, by enabling the selective modification of the mail costs table. Thus, the billing model for computing the bill for a customer can be changed without requiring reprogramming of an email billing application. Examples of reprogramming an email billing application include adding new programming instructions to an email billing application, modifying existing programming instructions of an email billing application, or deleting existing programming instructions of an email billing application. A cost computation component 130 can be used to compute the bill for a customer based on whatever billing model is associated with the mail costs table.

According to embodiments of the present invention, flexible email billing that does not require reprogramming of a billing system is provided. Billing models provide guidelines for computing a bill for a customers usage of an email service, according to one embodiment. A billing model for a customer is associated with an easy to modify mail cost table, according to another embodiment of the present invention. The billing model for a customer can easily be modified by associating a different billing model for the same customer with the mail costs table, thus, the billing model for computing the bill for a customer can be changed without requiring reprogramming of a billing system, according to embodiments of the present invention.

### Billable Metrics

As already stated, conventional email billing application typically have hardcoded billable metrics that are easy to measure. For example, typically conventional email billing application measure the number of email users. More specifically, a customer that has 100 users may be billed on the basis of having 100 users.

According to embodiments of the present invention, there is no limit to the billable metrics that can be used and therefore billable metrics that make sense are used rather than only using billable metrics that are easy to measure. For example, an email billing system could use billable metrics such as, but not limited to the number of users, the size of an email, the number of recipients of an email, the priority for delivering an email, properties of an attachment to the email, the security requirements for an email, the size of a mailbox, or the amount of data stored in an mailbox.

### Collecting Email Usage Information

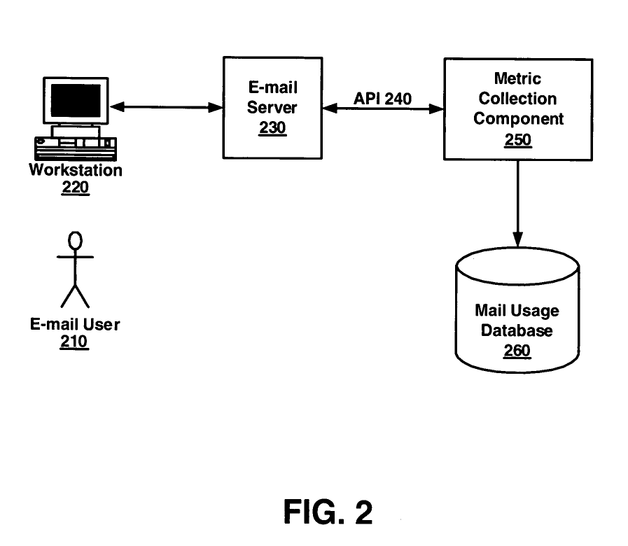

FIG. 2 depicts a block diagram of part of an email billing system in the context of an email system, according to embodiments of the present invention. The blocks that represent features in FIG. 2 can be arranged differently than as illustrated, and can implement additional or fewer features than what are described herein. Further, the features represented by the blocks in FIG. 2 can be combined in various ways.

FIG. 2 depicts an email user 210, a work station 220, an email server 230, a metric collection component 250, a mail usage database 260, and an application programming interface 240 (API) that is used between the email server 230 and the metric collection component 250. For example, the email user 210 can use the work station 220 to access electronic mail (email) provided by the email server 230. The metric collection component 250 establishes a connection with the email server 230 and receives usage information from the email server 230 via the API 240. The metric collection component 250 stores the usage information, for example, for each email in the mail usage database 260 for later processing. The metric collection component 250 can collect email usage information based on any type of billable metric, such as the number of users, the size of an email, the priority of an email, the priority of an email, among other things. According to yet another embodiment, an email service provider can increase their charges if more processing power or network bandwidth is required to provide the requested priority for an email.

The connection between the email server 230 and the metric collection component 250 can be terminated. For example, the connection can be terminated when the hardware that the email server 230 or the metric collection component 250 is being replaced.

The email server 230 can be, among other things, a Microsoft™ Exchange server and the API 240 can be Microsoft's™ Message Application Program Interface (MAPI™), among other things. According to embodiments of the present invention, any conventional email server 230 or conventional API can be used. Further, the email server 230 or the API 240 can be used without modification.

### Billing Models

According to another embodiment, the email usage information that the metric collection component 250 collects and stores in the mail usage database 260 is analyzed (e.g., measured) and used to calculate a bill for a customer. According to yet another embodiment, a billing model provides a guideline for computing a bill for a customer, as will become more evident.

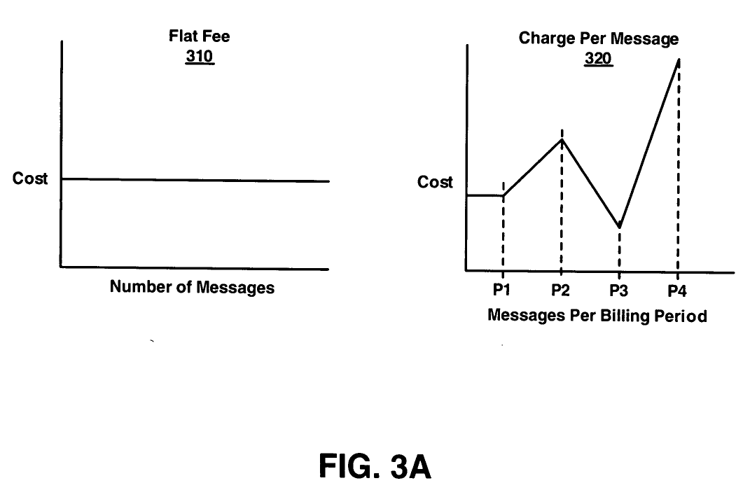

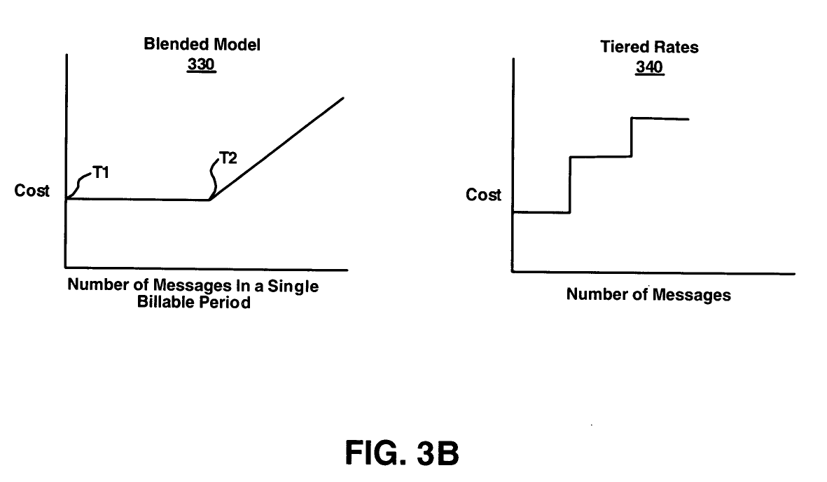

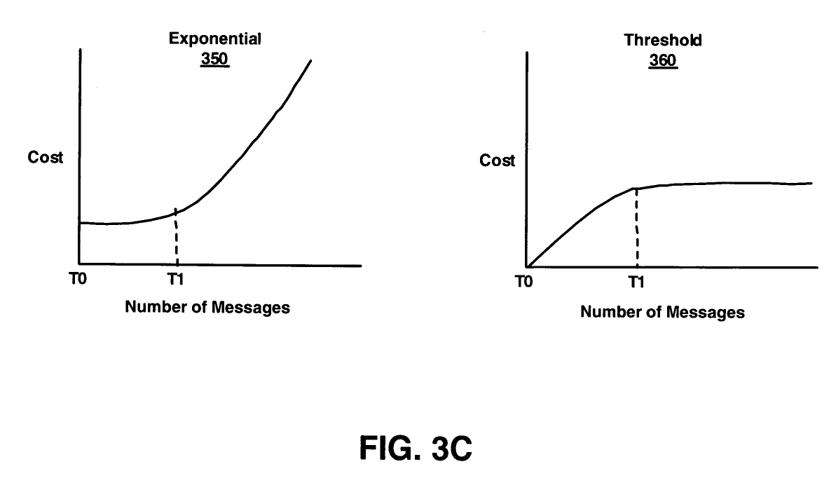

FIGS. 3A-3C depict various billing models, according to embodiments of the present invention. Billing model 310 in FIG. 3A is a flat rate billing model. The y-axis is the cost per message and the x-axis is the number of messages transmitted, for example, over a period of time, such as a month, a week, or a day. Since the same amount of money is charged for each message, the graph line is “flat,” hence this model is referred to as the “flat rate billing model.”

Billing model 320 in FIG. 3A is a charge per message billing model. The y-axis is the cost per billing period (denoted by periods 1, 2, 3) and the x-axis is the number of messages per billing period. In period P1, only a few messages were transmitted so cost was low, in period P2 more messages were transmitted so the cost was higher than in period P1, in period P3 very few messages were transmitted so the cost was very low, and finally in period P4 a lot of messages were transmitted so the cost was higher than in the previous periods P1, P2, P3.

Billing model 330 in FIG. 3B is a blended billing model. A blended billing model can be a combination of any two or more billing models. In the case of billing model 330, the y-axis is the cost for a single billing period and the x-axis is the number of messages in the single billing period. Billing model 330 is a blend of a flat rate billing model and a charge per message billing model. For example, a flat rate can be charged for a set number of messages, such as 200, as depicted from time T1 to time T2, and then once that set number of messages has been transmitted (e.g., when the 201^{st} message is transmitted), a charge per message billing model, as depicted from time T2 to time T3, can be used instead.

Billing model 340 in FIG. 3B is a tiered rate billing model. In the tiered rate billing model, the amount charged per message can be changed. For example, 1 cent per message may be charged for the first 100 messages, then 2 cents per message may be charged for the next 100 messages, and so on. Although the tiered rate billing model depicted in FIG. 2 is depicted with increasing costs, a tiered rate billing model can use decreasing costs. For example, 5 cents per message may be charged for the first 100 messages, then 3 cents per message may be charged for the next 100 messages and so on.

Billing model 350 in FIG. 3C is an exponential billing model. The y-axis is the cost and the x-axis is the number of messages. For example, with the exponential billing model, less is charged for the messages transmitted from time T0 to time T1, then after time T1 the amount charged for the messages increases exponentially.

Billing model 360 in FIG. 3C is a threshold billing model. The y-axis is the cost and the x-axis is the number of messages. For example, with the threshold billing model, the amount charged for the messages from time T0 to time T1 increases exponentially, but after time T1, the amount charged for messages reaches a threshold and therefore levels off.

### Mail Costs Table

A mail costs table can be used for defining a billing model for a customer, according to one embodiment. For example, the values associated with a mail costs table can be used for defining a billing model. Another billing model can be defined, for example, by selectively modifying the values associated with the mail costs table, which does not require reprogramming of an email billing application, as will become more evident.

A billing model associated with a mail costs table is used for calculating a bill for a customer, according to another embodiment. Table 1 is an example of a mail costs table, according to one embodiment.

TABLE 1
AN EXEMPLARY MAIL COSTS TABLE

| | METRIC IDENTIFIER | BASE | RATE | MAXIMUM |
|---|---|---|---|---|
| 1 | Message count | .15 | 0 | 0 |
| 2 | Message count | 5.00 | 0 | 200 |
| 3 | Message count | 0 | .04 | 400 |
| 4 | Message count | 0 | .07 | 600 |
| 5 | Message count | 0 | .08 | <none> |
| 6 | Attachment size | 0 | 0.001 | 50 |
| 7 | Attachment size | 0 | 0.002 | <none> |
| 8 | Priority High | .05 | 0 | 1 |
| 9 | Priority High | 0 | 0.03 | <none> |

The exemplary mail costs table depicted in Table 1 depicts a billing model, according to one embodiment. Each row is a billing rule associated with the billing model, according to another embodiment. The names in the METRIC IDENTIFIER column (also referred to as “attributes”) of the exemplary mail costs table depicted in Table 1 are Message count, Attachment size, and Priority High. Each attribute of a message is separately billable, according to easily customized billing rules. The metric identifier is used for identifying a billing rule. For example, rows 1-5 are for message count, rows 6 and 7 are for the size of the attachments, rows 8 and 9 are for the priority of messages. The base is a one time charge. The rate is an on going charge, such as a rate per message. The maximum indicates how long a billing rule is to be applied. For example, the maximum can indicate the number of messages or number of attachments that the billing rule is applied to. More than one billing rule can be used for a time period. For example the billing rules as depicted in rows 1-9 of table 1 could be used for one period of time.

The base and the rate can be used for defining a graph that depicts a billing model. For example, the formula for a line is y=m×+b, where b is the y-intercept and m is the slope of a line. The “base” is the y-intercept (e.g., b) and the “rate” is the slope (e.g., m), according to one embodiment.

For the purposes of illustration, assume that Table 1 depicts a mail cost table that defines a billing model for a customer. Table 1 has three sections. One section for message count type billing as indicated by the “message count” identifier for rows 1-5, a second section for attachment type billing as indicated by “attachment size” identifier for rows 6 and 7, and a third section for priority type billing as indicated by the “priority high” identifier for rows 8 and 9. Another billing model can be created by changing one or more values of the mail costs table. For example, another billing model could be created by modifying the rate in row 4 from 0.07 to 0.02.

Since the billing model can be easily changed without requiring reprogramming, sales personnel and customers can negotiate to use whatever billing model makes sense for a particular situation.

### Computing a Bill for a Customer

A customer's bill is computed based on the billing model associated with the mail costs table, according to one embodiment. For example a cost computation component 130 can query the email usage information from the mail usage database 260 and calculate a bill for a customer based on the customer's billing model in the mail costs table, as will become more evident.

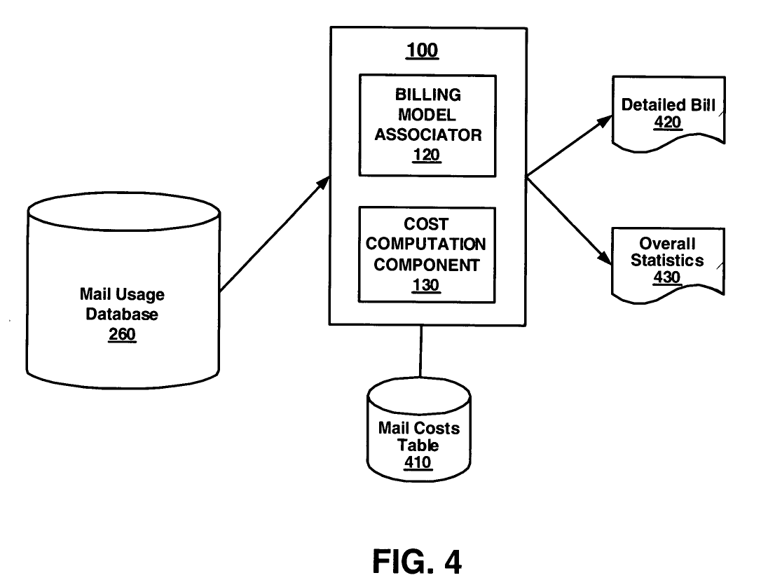

FIG. 4 depicts a block diagram of part of an email billing system in the context of an email system, according to embodiments of the present invention. The block that represent features in FIG. 4 can be arranged differently than as illustrated, and can implement additional or fewer features than what are described herein. Further, the features represented by the blocks in FIG. 4 can be combined in various ways.

FIG. 4 depicts the mail usage database 260 that stores usage information, the apparatus 100 (FIG. 1), a mail costs table 410, and reports, such as a detailed bill 420, and an overall statistics report 430. The billing model associator 120 is a user interface, according to one embodiment, that allows technicians or sales personnel to associate a billing model with the mail costs table 410. For example, sales person can use the billing model associator 120 to enter values, such as those depicted in Table 1, into the mail costs table 410. The cost computation component 130, according to one embodiment, queries the mail usage database 260 to determine what messages have been transmitted and to obtain usage information, about the messages in order to compute a bill for a customer based on the billing model associated with the mail costs table 410. Examples of usage information that can be collected includes but is not limited to the number of emails transmitted, the size of emails, the number of recipients of an email, the priority of an email, the security requirements of an email, the size of an email box, or the amount of data stored in an email box.

The cost computation component 130 can read each record in the mail usage database 260. Using the billing model stored in the mail costs table 410, the cost computation component 130 can calculate the detailed charges for each email message. Detailed results are recorded in the detailed bill 420, according to one embodiment. Overall results are recorded in the overall statistics report 430, according to another embodiment. In yet another embodiment, the reports 420, 430 are printed and distributed to the appropriate customer. In still another embodiment, the reports 420, 430 are filed on a web server so that the customer can refer to current and previous reports 420, 430 as desired.

The following illustration assumes that the mail usage database 260 includes usage information for a billing period, such as a month, indicating that a customer transmitted 850 messages, 50 of the 850 messages had attachments that were each 10 kilobytes in size, and 3 of the 850 messages were transmitted with high priority. Further, the following illustration assumes that the cost computation component 130 queries the mail usage database 260, determines that the customer transmitted 850 messages, etc., and computes the bill for the customer based on the billing model depicted in Table 1.

According to one embodiment, a usage counter and a rate index pointer is associated with each billing type. For example, the cost computation component 130 can associate one usage counter and one rate index pointer with the message count type billing (e.g., rows 1-5 of Table 1), a second usage counter and second rate index pointer with the attachment type billing (e.g., rows 6 and 7 of Table 1) and a third usage counter and third rate index pointer with the priority type billing (e.g., (rows 8 and 9 of Table 1). At the beginning of processing, the cost computation component 130 can initialize the usage counters to zero and the respective rate index pointers to point at the first row in the sections that the respective rate index pointers are associated with. In this case, the first rate index pointer would be initialized to point to row 1, the second rate index pointer would be initialized to point to row 6 and the third rate index pointer would be initialized to point to row 8.

In this illustration, row 1 indicates that there is a fifteen cent charge for an email account even if no messages are transmitted. When the first message is transmitted, for example, the cost computation component 130 can advance the rate index pointer for this section to row 2.

Row 2 indicates that there is a $5 base charge for the first 200 e-mail messages that are transmitted. For example, the cost computation component 130 will increment the usage counter for each message that is transmitted. When the usage counter reaches the maximum of 200, the cost computation component 130 can determine that the bill is $5.15, for example, and advance the rate index pointer for this section to row 3.

Row 3 indicates that after a maximum of 200 messages have been transmitted, all subsequently transmitted messages are charged at 4 cents each, up to a total of 400 messages. When the usage counter reaches the maximum of 400, the bill will be $13.15 (e.g., $5.15+(4 cents×200 messages)/100 cents in a dollar), for example, and the rate index pointer for this section can be advanced to row 4.

Row 4 shows an increased rate of 7 cents for the next 200 transmitted messages. When the usage counter reaches the maximum of 600, the bill will be $27.15 ($13.15+(7 cents×200 messages)/100 cents in a dollar), for example, and the rate index pointer for this section can be advanced to row 5.

Row 5 shows another increased rate to 8 cents for all messages (as indicated by “none” in the maximum column) transmitted after the first 600 messages (as indicated by the 600 in the maximum column for row 4). So for the sake of illustration, assuming that a total of 850 messages (resulting in 250 messages that apply to row 5) are transmitted in a billing period, the part of the bill based on this section of the mail cost table would be $47.15 (e.g., $27.15+(8 cents×250 messages)/100).

Row 6 indicates that the first 50 attachments are charged at a rate of $0.001 per kilobyte. For example, if a message is transmitted with an attachment that is 10 kilobytes in size, then the charge would be 1 cent. If a second message is transmitted with two attachments that are 15 kilobytes each in size, then the charge would be 3 cents. For the sake of continuing the illustration, assume that 50 messages are transmitted, each with one attachment that is 10 kilobytes in size. In this later case, the bill for this section would be 50 cents (e.g., $0.001×50 messages×10 kilobytes), the usage counter would reach the maximum of 50, and the rate index pointer for this section would be advanced to point to row 7, for example.

Row 7 indicates that all subsequent attachments are charged at a rate of $0.002 per kilobyte. For the sake of illustration, assume that 2 more attachments are transmitted in emails each with a size of 15 kilobytes for a total of 30 kilobytes. In this case, the bill for this section would be 56 cents (e.g., 50 cents+0.002×2 attachments×15 kilobytes).

Rows 8 and 9 indicate that the first time a high priority message is transmitted, a five cent charge is incurred, but all subsequent high priority messages incur a three cent charge. The rate index pointer initially points to row 8 and the usage counter for this section is initially 0. For the sake of illustration, assume for this section that 3 high priority messages are transmitted. After the first high priority message is transmitted, the charge is five cents (as indicated in the base column for row 8), the usage counter is 1 and the rate index pointer is advanced to row 9. After the next 2 high priority messages are transmitted, the charge is 11 cents (5 cents+2 high priority messages×3 cents).

For the sake of illustration, at this point in time, the total bill would be $47.82 (e.g., $47.15 for the message count section+56 cents for the attachment section+11 cents for the priority section).

As can be seen, by changing the values in the mail cost table, the billing model for a customer can be changed without requiring reprogramming of an email billing system. For example, a customer and the email service provider's sales personnel could agree that the rate of billing should decrease rather than increase as more messages are transmitted. In this case, the billing model associator 120 can be used to modify the rate in row 4 from 0.07 to 0.02. In another example, a customer may not be charged for high priority emails. In this case, the billing model associator 120 can be used to delete rows 8 and 9 from the mail costs table 410. These are just two examples of how a new billing model could be associated with a mail cost table for a customer.

Embodiments of the present invention allow the service provider's salesmen to be more creative in selling an email service. Embodiments of the present invention allow the easy implementation of many billing models for calculating bills, without reprogramming. The salesman can easily adjust the billing model as the customer's needs change. This flexibility of changing billing models empowers the salesman, thus increasing his motivation to sell the email service.

### Reports

Consumers of the electronic mail service want to understand the details about the charges of their bill. Embodiments of the present invention allow for detailed reporting of charges per user. In addition, overall usage information allows a manager to understand how the department's usage affects costs, thus providing the means for management to direct changes in behavior of the staff (for example, to eliminate abuses). The departmental metrics might also be used to renegotiate individual rates of charge with the service provider.

According to one embodiment, reports, such as but not limited to a detailed bill 420 and overall statistics report 430, are generated. For example, a detailed bill 420 can include a break down of the bill for each type of bill. More specifically, a break down of the bills based on the cost due to the number of messages transmitted, the cost due to the number of attachments and the size of the attachments transmitted, the cost due to high priority messages. The cost due to the number of recipients, the cost due to encrypted messages, the cost due to the size of the mail box and so on. Further, the detailed bill 420 may break down the bill based on subgroups associated with a customer. For example, the detailed bill 420 may break down the bill based on departments or even employees working for a customer.

In another example, the overall statistics report 430 could include the number of messages transmitted, the number of attachments and the size of the attachments transmitted, the number of high priority messages, the number of encrypted messages, the size of the mail box and so on.

A manager could use the detailed bill 420 or the overall statistics report 430 to analyze the email usage for their entire organization, a subset of the organization like a department, for an individual employee's usage usage, according to one embodiment. An employee could use the detailed bill 420 to analyze their own usage. According to another embodiment, the reports 420, 430 can be generated per billing period, per month, per week, per day, or even on demand, among other things. The reports 420, 430 can be generated on paper or electronically.

### Operational Examples

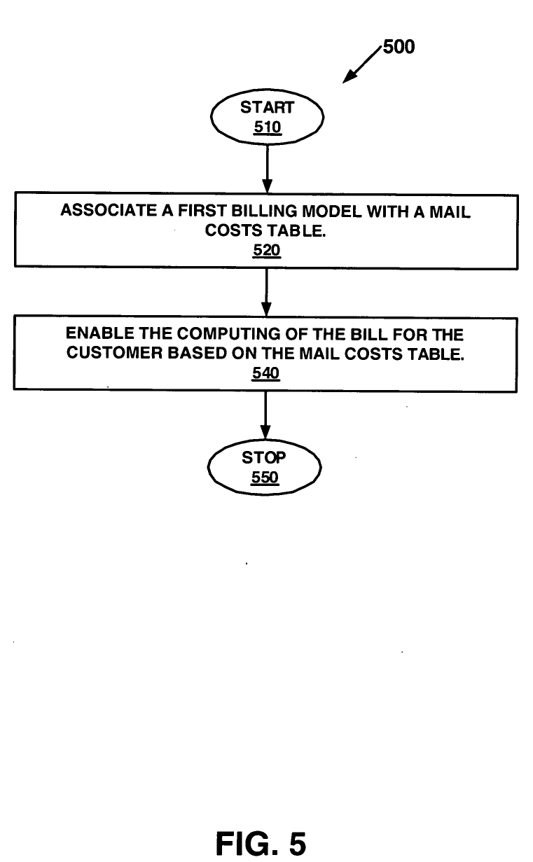

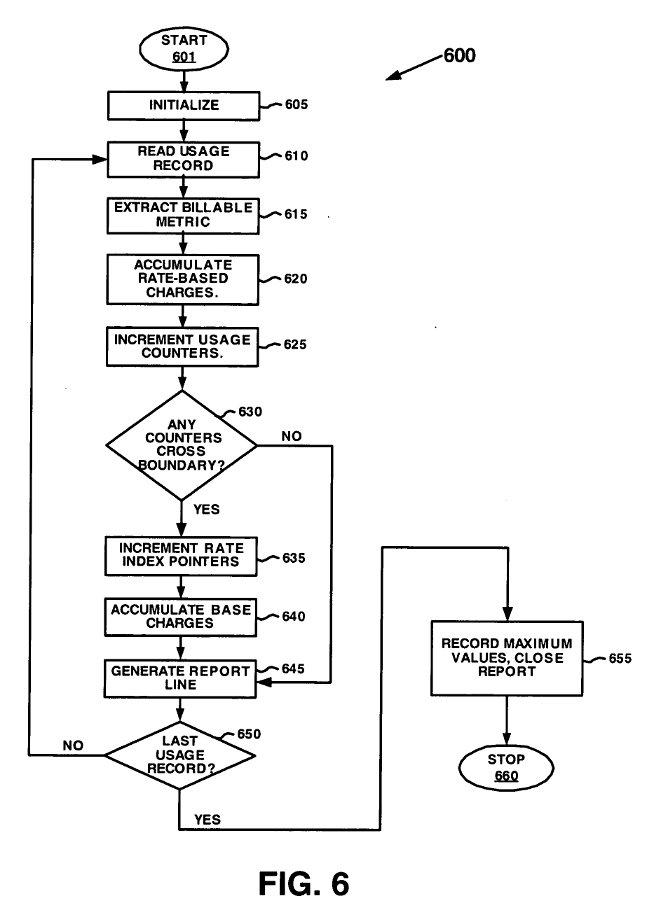

FIG. 5 depicts flowchart 500 for a method of providing flexible email billing without requiring reprogramming, according to embodiments of the present invention. FIG. 6 depicts flowchart 600 for a method of computing a bill for a customer based on a billing model, according to embodiments of the present invention. Although specific steps are disclosed in flowcharts 500, 600, such steps are exemplary. That is, embodiments of the present invention are well suited to performing various other steps or variations of the steps recited in flowcharts 500, 600. It is appreciated that the steps in flowcharts 500, 600 may be performed in an order different than presented, and that not all of the steps in flowcharts 500, 600 may be performed. All of, or a portion of, the embodiments described by flowcharts 500, 600 can be implemented using computer-readable and computer-executable instructions which reside, for example, in computer-usable media of a computer system or like device.

As described above, certain processes and steps of the present invention are realized, in one embodiment, as a series of instructions (e.g., software program) that reside within computer readable memory of a computer system and are executed by the of the computer system. When executed, the instructions cause the computer system to implement the functionality of the present invention as described below.

For the purposes of illustration, the discussion of flowcharts 500, 600 shall refer to: (1) the structures depicted in FIGS. 2 and 4, and (2) the mail costs table 410 as depicted in Table 1.

In step 510, the process starts.

In step 520, a first billing model is associated with a mail costs table, according to one embodiment. For example, a sales person can use the billing model associator 120 to enter a first billing model such as that depicted in Table 1 into the mail costs table 410. The first billing model provides a guideline for computing a bill for a customer using an email service, as described herein.

The mail costs table can be selectively modified without requiring the reprogramming of the email billing application, according to one embodiment. For example, a customer and the email service provider's sales personnel could agree that the rate of billing should decrease rather than increase as more messages are transmitted. In this case, the billing model associator 120 can be used to modify the rate in row 4 from 0.07 to 0.02. In modifying one or more values of the mail costs table (such as modifying 0.07 to 0.02 in row 4), a second billing model is associated with the mail costs table. In another example, a customer may not be charged for high priority emails. In this case, the billing model associator 120 can be used to delete rows 8 and 9 from the mail costs table 410. In this case, the second model would not charge for high priority emails.

In step 540, the computing of the bill for the customer based on the mail costs table is enabled, according to yet another embodiment. For example, for the sake of illustration, the cost computation component 130 could be used to bill the customer based on the first billing model and later used for billing the customer based on a second billing model after the mail costs table has been selectively modified, using embodiments described herein.

In step 550, the process stops.

According to one embodiment, the bill for a customer can be computed based on a billing model as defined by the mail costs table as described below with respect to flowchart 600.

In step 601 the process starts.

In step 605, for each billing type (such as the message count type, the attachment count and size type, and the priority type): initialize all usage counters to zero, and initialize all rate index pointers to the corresponding initial value in the mail costs table 410.

At step 610, for each usage record (e.g., row) in the mail usage database 260, extract usage information for a single electronic mail message. The cost computation component 130 can extract billing metrics, for example, by querying the mail usage database 260.

At step 615, for each of the billing metrics, look up the corresponding billing rule in the mails cost table 410.

In step 620, the multiplicative (rate based) charge are accumulated for each billing type, such as, but not limited to, the size of the e-mail message body multiplied by the rate of charge for the message body, and the size of each attachment multiplied by the rate of charge for that type of attachment. For example, referring to the illustration described in the “Computing a Bill for a Customer” section, examples of multiplicative charges are 4 cents×200 messages for row 3, 7 cents×200 messages for row 4, 8 cents×250 messages for row 5, $0.001×50 messages×10 kilobytes for row 6, and 2 high priority messages×3 cents for row 9.

In step 625, the usage counters are incremented for each billing type, such as the message count billing type (rows 1-5 of Table 1), the attachment billing type (rows 6 and 7 of Table 1), and the priority billing type (rows 8 and 9 of Table 1). Counters that do not apply to the current usage record are not incremented. For example, the counter for attachments is not incremented if the usage record indicates that the currently processed message did not have an attachment. Other counters could be implemented for other billing types. For example, the mail costs table 410 could include a billing type for the number of recipients.

At decision box 630, for each of the usage counters, the value of the usage counter is compared to the maximum value that is allowed for that billing rule (e.g., row) in the mail costs table 410. If the usage counter has reached the maximum value then, the corresponding rate index pointer is incremented to the next billing rule in the mail costs table 410 at step 635 and the base charged for transitioning to the next billing rule is accumulated at step 640. Processing returns to 610 and continues until the last billing rule is processed.

In step 645, an output report line item is generated, containing the detailed costs for this message in the detailed report.

At decision box 650, continue processing at step 610 if any records remain in the Mail Usage Database.

In step 655, the maximum values of the usage counters are recorded in the overall statistical report, indicating the change in rates at each threshold, as indicated by the maximums and rates in the mail costs table 410.

In step 660, the process stops.

### CONCLUSION

According to embodiments of the present invention, an email billing system can be easily modified to use different billing models without requiring reprogramming.

According to embodiments of the present invention, customers are provided with detailed information to analyze and even justify their bills.

According to embodiments of the present invention, sales teams are more empowered to sell an email service by virtue of the increased flexibility of the billing solution. For example, sales teams can negotiate a billing model with a customer and easily implement the billing model in the matter of a few minutes by changing values in a mail costs table without waiting on programmers to re-write the code for the email billing system.

According to embodiments of the present invention, service providers can achieve higher profit margins because the costs of customizing the email billing service will be low, because customer abuses can be prevented, and because new email billing application will not need to be produced from scratch.

What is claimed is:

1. A method of providing email billing without requiring reprogramming of an email billing application, the method comprising:
associating a first billing model with a mail costs table, wherein the first billing model provides a guideline for computing a bill for a customer using an email service, wherein the mail costs table can be selectively modified without requiring the reprogramming of the email billing application; and
enabling the computing of the bill for the customer based on the mail costs table.

2. The method as recited in claim 1, further comprising:
collecting usage information describing how the customer uses the email service;
analyzes the usage information and computing the bill for the customer based on the first billing model.

3. The method as recited in claim 2, wherein the collecting of the usage information further comprises:
collecting usage information based on billable metrics selected from a group consisting of size of an email message, number of recipients, priority for delivering an email message, properties of an attachment, security requirements for an email, size of an email box, the amount of data stored in the email box.

4. The method as recited in claim 3, wherein the properties of the attachment are selected from a group consisting of type of the attachment, size of the attachment, and number of attachments.

5. The method as recited in claim 2, wherein the collecting of the usage information further comprises:
collecting of the usage information without requiring modification of an conventional application protocol interface associated with a email server.

6. The method as recited in claim 1,
enabling the association of a second billing model with the mail costs table by selectively modifying the mail costs table without requiring the reprogramming of the email billing application; and
enabling the computing of the bill for the customer based on the second billing model.

7. The method as recited in claim 6, wherein the associating of the first billing model and the associating of the second billing model with the mail costs table, further comprises:
the associating of the first billing model and the second billing model with the mail costs table, wherein the first and second billing models are selected from a group consisting of flat rate billing model, charge per message billing model, blended billing model, tiered rates billing model, exponential billing model, and threshold billing model.

8. The method as recited in claim 1, wherein the associating the first billing model with the mail costs table further comprises:
associating the first billing model with a mail costs table that has attributes selected from a group consisting of a base, a rate, and a maximum.

9. An apparatus providing email billing without requiring reprogramming, the method comprising:
a billing model associator for associating a first billing model with a mail costs table, wherein the first billing model provides a guideline for computing a bill for a customer using an email service, wherein the mail costs table can be selectively modified without requiring the reprogramming of the email billing application; and
a cost computation component for enabling the computing of the bill for the customer based on the mail costs table

10. The apparatus of claim 9, further comprising:
a metric collection component for collecting usage information describing how the customer uses the email service; and
wherein the cost computation component analyzes the usage information and computing the bill for the customer based on the first billing model.

11. The apparatus of claim 10, wherein the cost computation component collects usage information based on billable metrics selected from a group consisting of size of an email message, number of recipients, priority for delivering an email message, properties of an attachment, security requirements for an email, size of an email box, the amount of data stored in the email box.

12. The apparatus of claim 11, wherein the properties of the attachment are selected from a group consisting of type of the attachment, size of the attachment, and number of attachments.

13. The apparatus of claim 10, wherein the cost computation component collects the usage information without requiring modification of an conventional application protocol interface associated with a email server.

14. The apparatus of claim 9, wherein
the billing model associator enables the association of a second billing model with the mail costs table by selectively modifying the mail costs table without requiring the reprogramming of the email billing application; and
the cost computation component enables the computing of the bill for the customer based on the second billing model.

15. The apparatus of claim 14, wherein the first and second billing models are selected from a group consisting of:
flat rate billing model, charge per message billing model, blended billing model, tiered rates billing model, exponential billing model, and threshold billing model.

16. The apparatus of claim 9, wherein the mail costs table has attributes selected from a group consisting of a base, a rate, and a maximum.

17. A computer-usable medium having computer-readable program code embodied therein for causing a computer system to perform a method of providing email billing without requiring reprogramming, the method comprising:
associating a first billing model with a mail costs table, wherein the first billing model provides a guideline for computing a bill for a customer using an email service, wherein the mail costs table can be selectively modified without requiring the reprogramming of the email billing application; and
enabling the computing of the bill for the customer based on the mail costs table.

18. The computer-usable medium of claim 17, wherein the computer-readable program code embodied therein causes a computer system to perform the method, and wherein the method further comprises:
collecting usage information describing how the customer uses the email service;
analyzes the usage information and computing the bill for the customer based on the first billing model.

19. The computer-usable medium of claim 18, wherein the computer-readable program code embodied therein causes a computer system to perform the method, and wherein the collecting of the usage information further comprises:
collecting usage information based on billable metrics selected from a group consisting of size of an email message, number of recipients, priority for delivering an email message, properties of an attachment, security requirements for an email, size of an email box, the amount of data stored in the email box.

20. The computer-usable medium of claim 19, wherein the computer-readable program code embodied therein causes a computer system to perform the method, and wherein the properties of the attachment are selected from a group consisting of type of the attachment, size of the attachment, and number of attachments.

21. The computer-usable medium of claim 18, wherein the computer-readable program code embodied therein causes a computer system to perform the method, and wherein the collecting of the usage information further comprises:
collecting of the usage information without requiring modification of an conventional application protocol interface associated with a email server.

22. The computer-usable medium of claim 17, wherein the computer-readable program code embodied therein causes a computer system to perform the method, and wherein the associating of the first billing model with the mail costs table further comprises:
the associating of the first billing model with the mail costs table, wherein the first second billing model is selected from a group consisting of: flat rate billing model, charge per message billing model, blended billing model, tiered rates billing model, exponential billing model, and threshold billing model.
